(19) United States
(12) Patent Application Publication
(10) Pub. No.: US 2009/0014911 A1
(43) Pub. Date: Jan. 15, 2009

(54) STAMPING APPARATUS AND STAMPING METHOD

(75) Inventor: Takuya Hayasaka, Tokyo (JP)

Correspondence Address: LOWE HAUPTMAN HAM & BERNER, LLP, 1700 DIAGONAL ROAD, SUITE 300, ALEXANDRIA, VA, 22314, US

(73) Assignee: LINTEC CORPORATION, TOKYO (JP)

(21) Appl. No.: 11/911,259

(22) PCT Filed: Apr. 24, 2006
(86) PCT No.: PCT/JP2006/308508

§ 371 Date: Oct. 11, 2007

(30) Foreign Application Priority Data
May 16, 2005 (JP) 2005-142924

(51) Int. Cl. B28B 11/08; B28B 3/00

(52) U.S. Cl. 264/293; 425/470

(57) ABSTRACT

There are provided with a first supporting unit 12 which supports a disk substrate 11, a second supporting unit 14 which supports a stamper 13, a pressing member 15 which applies a pressing force on the disk substrate 11 and the stamper 13, and a fore-contact preventing member 17 which abuts against a peripheral area of the stamper 13 to maintain a not-yet-contacted area in a suspended posture, wherein the stamper 13 which is maintained in such posture is pressed by the pressing member 15, whereby the stamper is stamped on the disk substrate.

### TECHNICAL FIELD

The present invention relates to a stamping apparatus and a stamping method, particularly to a stamping apparatus and a stamping method suitable for stamping a stamper in order to form fine convex-concave for information recording on a substrate comprising an optical recording medium such as a compact disc (CD), a digital versatile disc (DVD), a laser disc (LD) and a blu-ray disc (BD).

### BACKGROUND ART

As for an optical recording medium such as a compact disc, a configuration of, for example, providing a resin layer on a surface of a disk substrate made of polycarbonate and the like; forming fine convex-concave such as pits on the resin layer; and sequentially laminating a reflective film and a protective film thereon; has been adopted.

To form such convex-concave, a sequence of steps that providing a resin layer on one surface of a disk substrate; stamping a stamper having a surface with convex-concave on the resin layer; and then detaching the stamper after curing the resin layer by ultraviolet ray irradiation; has been adopted. The stamping with the stamper is required to be performed in a state capable of preventing air bubbles from being trapped in the resin layer so as to maintain geometric reproducibility of the convex-concave formed on the stamper with a high-accuracy to be able to keep up with the advancement of high-density technology. Therefore, to stamp with the stamper on the resin layer with a high degree of accuracy is a major issue in manufacturing optical recording media.

As a heretofore known stamping apparatus, an example of such an apparatus is disclosed in the patent document 1. The apparatus according to the patent document 1 comprises a stationary side mold which supports a disk substrate; and a movable side mold which supports a stamper; wherein these stationary side mold and the movable side mold are fit to each other, and a stamping force is imparted to perform stamping in a decompression ambient or a vacuum ambient, thereby intending to prevent air bubbles from being trapped in the recording layer (resin layer) on the disk substrate.

Patent Document 1: Japanese Patent Application Laid-Open No. 2002-42387

### DISCLOSURE OF THE INVENTION

### PROBLEMS TO BE SOLVED BY THE INVENTION

However, the apparatus for stamping described in the patent document 1 has inconveniencies due to the configuration that the area where the stamper and the disk substrate to be closely contacted has to be maintained the vacuum ambient or at least the decompression ambient inevitably, that causes not only troublesome tasks for pressure control but also complexity of the apparatus structure. Moreover, interspaces formed by stamping in a vacuum ambient also cause warps and wrinkles of the resin layer in the atmospheric pressure ambient, therefore these interspaces have to be prevented to perform stamping even in the vacuum ambient. Thus, stamping in the vacuum ambient cannot be judged as the most appropriate. Accordingly, as a factor that causes such interspaces in stamping is considered as “fore-contact”, that means objects to be stamped are contacted to each other before stamping by pressing.

### OBJECT OF THE INVENTION

The present invention is made in view of the above inconveniencies, and an object of the present invention is to provide a stamping apparatus and a stamping method capable of stamping efficiently by removing air even if there has been air between the objects to be stamped, and being capable of eliminating necessity of devices for maintaining a decompression ambient by preventing fore-contact.

Additionally, another object of the present invention is to provide a stamping apparatus and a stamping method capable of stamping a stamper in a state of preventing trapping air bubbles and wrinkles and also warps of a resin to form an information recording layer on a disk substrate which comprises an optical recording medium, and thereby allowing geometric reproducibility of fine convex-concave formed on the disk substrate to be maintained with high-accuracy.

### MEANS FOR SOLVING THE PROBLEMS

In order to achieve the above object, the present invention adopts a stamping apparatus, which is provided with a first supporting unit which supports a first plate-like member; a second supporting unit which supports a second plate-like member for stamping on the first plate-like member, and is disposed above the first plate-like member; and a pressing member which applies a pressing force on the first and the second plate-like members to perform stamping; comprises a fore-contact preventing member for forming a not-yet-contacted area by abutting against a peripheral area of either the first plate-like member or the second plate-like member; wherein the pressing member applies the pressing force from the opposite side of the abutted position by the fore-contact preventing member to perform stamping of the first plate-like member with the second plate-like member.

The present invention is configured that the first plate-like member is a disk substrate comprising an optical recording medium while the second plate-like member is a stamper for transferring fine convex-concave onto the surface of a resin layer provided on the disk substrate; and the fore-contact preventing member abuts against the stamper to maintain the not-yet-contacted area of the stamper in a suspended posture.

The present invention is configured that the first supporting unit comprises a positioning pin to perform centering of the disk substrate and the stamper; and the pressing force is applied in a state that the positioning pin performs centering the disk substrate and the stamper so as to restrict relative slides of the disk substrate and the stamper.

The present invention further comprises a detaching member having a diameter smaller than a diameter of a hole provided in the center of the disk substrate as well as an external diameter larger than the diameter of a hole provided in the center of the stamper, being provided availably for insertion alternatively instead of the positioning pin; wherein the detaching member performs a function of entering between the disk substrate and the stamper for pushing up the stamper so as to detach the stamper from the disk substrate.

The detaching member comprises an air supplying means for supplying air between the disk substrate and the stamper in a state that the stamper is pushed up.

The present invention provides a stamping method, which includes stamping of a first plate-like member with a second plate-like member by applying a pressing force on the first and the second plate-like members in a state of their faying surfaces; comprises forming a not-yet-contacted area by abutting against a peripheral area of either the first plate-like member or the second plate-like member; and applying a pressing force from the opposite side of the abutted position thereby removing air from between the first plate-like member and the second plate-like member.

The stamping method of the present invention further comprises a function of detaching the second plate-like member from the first plate-like member by pushing up the second plate-like member while jetting out air therebetween after stamping the first and the second plate-like members.

Meanwhile, the “not-yet-contacted area” in the present description means an area remaining without inter-contacts between the opposing surfaces of the first plate-like member and the second plate-like member which are to be gradually contacted closely under application of the pressing force, therefore the not-yet-contacted area is getting smaller as application of the pressing force progresses, and then eventually the air is to become nonexistent.

### EFFECT OF THE INVENTION

According to the present invention, the first plate-like member and the second plate-like member are not closely contacted to each other on the entire opposing surfaces area simultaneously for stamping, but only one edge, that is the opposite side of the abutted position with the fore-contact preventing member, is first contacted closely to each other. Then, the pressing member relatively moves toward the fore-contact preventing member, so that the first and the second plate-like members can be closely contacted while removing air which may have been therebetween. Therefore, even if air has remained between the first and the second members, such air is to be removed to the outer periphery, thereby preventing the fore-contacts so that trapped air bubbles and wrinkles and also warps of the resin between the first and the second plate-like members can be prevented.

Also, the not-yet-contacted area can be maintained in a suspended posture by only abutting the fore-contact preventing member against the periphery of any one of two plate-like members, thereby eliminating the necessity of tilting the plate-like members while adsorbing their entire surfaces therefore the configuration can be distinctly simplified.

Moreover, since air bubbles are prevented from being trapped, the fine convex-concave for forming pits formed on the stamper can be transferred with sufficient accuracy, thus a high geometric reproducibility of convex-concave on the resin layer can be reliably maintained.

Furthermore, since the pressing force is applied in a state that the positioning pin is positioned in the both centers of the disk substrate and the stamper, a problem that the disk substrate and the stamper relatively slide in a planar direction caused by the pressing force can be prevented unfailingly, thus the stamping position can be reliably maintained with sufficient accuracy.

Additionally, in the case that the detaching member comprises the air supplying means, force for detachment after stamping with the stamper can be diminished, also, the stamper can be detached toward the direction perpendicular to the surface of the stamper, therefore the transferring accuracy of the convex-concave to be formed on the resin layer can be maintained with high accuracy.

### BRIEF DESCRIPTION OF THE DRAWINGS

FIG. 1 is a schematic front view of a stamping apparatus according to the embodiment.

FIG. 2 is an enlarged view of an area A in FIG. 1.

FIG. 3 is a schematic front view showing a state where the disk substrate is supported by the suction table.

FIG. 4 is a schematic front view showing a state where the protective sheet is peeled off from the disk substrate.

FIG. 5 is a schematic front view showing a state where the stamper is positioned above the disk substrate via the second supporting unit.

FIG. 6 is a schematic front view showing a state where centering of the disk substrate and the stamper is performed.

FIG. 7 is a schematic front view showing an initial state of stamping with the stamper on the disk substrate.

FIG. 8 is a schematic front view showing a middle state of stamping with the stamper on the disk substrate.

FIG. 9 is a schematic front view showing a state where the stamper is detached from the disk substrate by the detaching member.

FIG. 10 is an enlarged view of an area B in FIG. 9.

FIG. 11 is a schematic front view showing a state where the stamper is returning to the initial position by the second supporting unit after completion of the transfer.

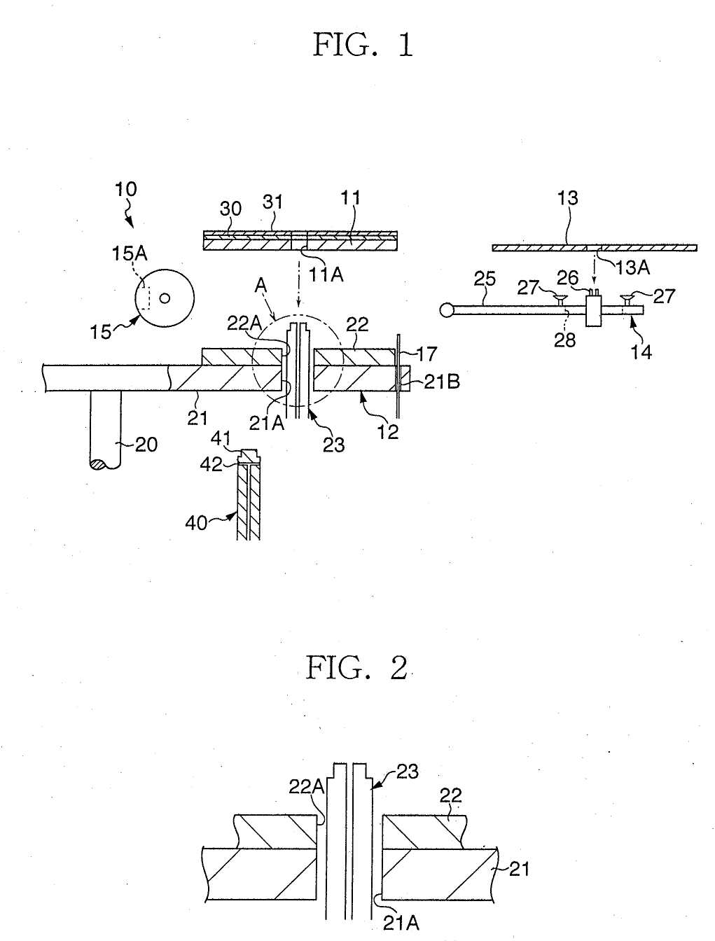

### EXPLANATION OF REFERENCE NUMERALS

10 stamping apparatus
11 disk substrate (first plate-like member)
12 first supporting unit
13 stamper (second plate-like member)
14 second supporting unit
15 pressing member
17 fore-contact preventing member
40 detaching member
42 air ejection means

### BEST MODE FOR CARRYING OUT THE INVENTION

Hereinafter, embodiment of the present invention will be described with reference to the drawings.

FIG. 1 is a schematic configuration diagram showing a stamping apparatus according to the embodiment. In the drawing, a stamping apparatus 10 comprises a first supporting unit 12 which supports a disk substrate 11 as a first plate-like member; a second supporting unit 14 which supports a stamper 13 as a second plate-like member; a pressing member 15 which applies pressing force on the disk substrate 11 and the stamper 13 to perform stamping in a state of their faying surfaces; and a fore-contact preventing member 17 which abuts against a peripheral area of the stamper 13 to maintain a not-yet-contacted area in a suspended posture to the disk substrate 11.

The first supporting unit 12 comprises a disk-like main table 21 which is supported by a rotating drive shaft 20 located in the central area, and is capable of rotating in a plane surface; a disk-like suction table 22 which is provided on the upper surface side in the near periphery of the main table 21; and a positioning pin 23 which is capable of penetrating both center holes 21A and 22A of the main table 21 and the suction table 22, and going through a center penetration hole 11A of the disk substrate 11 and a center penetration hole 13A of the stamper 13. The positioning pin 23 is provided movably advancing upward and retracting downward via a not-shown cylinder from a backed off position beneath the main table 21, and is capable of performing centering of the disk substrate 11 and the stamper 13 disposed on the suction table 22 by upsizing radially (in the directions indicated by arrows in FIG. 3) via the not-shown cylinder.

The second supporting unit 14 comprises a turning arm 25; and a plurality of suction pads 27 which are provided on the free end side of the turning arm 25 so as to suck and hold the stamper 13; a positioning pin 26 which is provided separately from the turning arm 25 is disposed in the substantially center of these suction pads 27 in order to perform positioning of the stamper 13. In addition, the turning arm 25 is provided with a hole 28 so as not to interfere with the positioning pin 26. The second supporting unit 14 is disposed higher than the upper surface position of the suction table 22, thereby allows the stamper 13 to be positioned right above the suction table 22 when the turning arm 25 is rotated substantially 180 degrees around in the vertical plane from the position shown in FIG. 1.

The disk substrate 11 is made of a molding material such as polycarbonate into a disk-like shape; and an energy ray curable resin layer, an ultraviolet curable resin layer 30 in this embodiment, and a protective sheet 31 are laminated on one surface (on the upper surface in FIG. 1) thereof. On the upper surface of the stamper 13 in FIG. 1, fine convex-concave are formed for transferring and forming predetermined convex-concave onto the resin layer 30.

The pressing member 15 is configured of a roll. The pressing member 15 is provided rotatably and movably in the horizontal direction via a not-shown motor and a cylinder, to roll and move with contacting onto the upper surface of the stamper 13 thereby applying a pressing force thereon in order to stamp the stamper 13 on the disk substrate 11. In the embodiment, the pressing member 15 is formed to have a recess 15A on the periphery thereof, and is configured that a tip of the positioning pin 23 is set to fit into the recess 15A when the pressing member 15 moves pressing the stamper 13, thereby, so as not to generate a physical interference with the head of the positioning pin 23.

The fore-contact preventing member 17 is provided movably advancing upward and retracting downward from a backed off position beneath the main table 21 penetrating a through-hole 21B which is formed in the near peripheral edge of the main table 21. The fore-contact preventing member 17 is supported by a not-shown cylinder, and is configured to prop up a periphery of the stamper 13 from the lower surface side when the stamper 13 is stamped on the disk substrate 11, thereby allows the not-yet-contacted area to be maintained in a suspended posture until the stamper 13 completes stamping.

A detaching member 40 which is possible to insertion alternatively instead of the positioning pin 23 is disposed under the main table 21. The detaching member 40, which is to be used for detaching the stamper 13 from the faying surface after the disk substrate 11 is stamped with the stamper 13, has a diameter smaller than the center penetration hole 11A of the disk substrate 11 as well as an external diameter larger than the center penetration hole 13A of the stamper 13, and is provided movably in the lateral directions between the position right beneath the hole 21A formed in the main table 21 and the backed off position therefrom as well as movably advancing upward and retracting downward via a not-shown cylinder. The detaching member 40 is configured of a reduced-diameter portion 41 which is provided on the upper end thereof engageably with the center penetration hole 13A of the stamper 13; and an air ejection means 42 having openings on the external surface thereof in a slightly lower position than the reduced-diameter portion 41; to be capable of feeding air between the disk substrate 11 and the stamper 13 supplied from an not-shown air supply source.

Hereinafter, a stamping method according to the present embodiment will be described.

When the main table 21 is set to the position shown in FIG. 1 by rotating toward a predetermined angular position; the positioning pin 23 enters into the main table 21 from the lower surface side thereof, and goes up through the center of the suction table 22 out to a higher position thereof.

About that time, the disk substrate 11 is transferred onto the suction table 22 via a not-shown transfer unit; and the positioning pin 23 enters into the center penetration hole 11A of the disk substrate 11; the positioning pin 23 is upsized radially via a not-shown cylinder, and then the disk substrate 11 is to be sucked and held after centering is performed (see FIG. 3). In this regard, the disk substrate 11 is transferred in a state that the protective sheet 31 is positioned on the upper surface thereof.

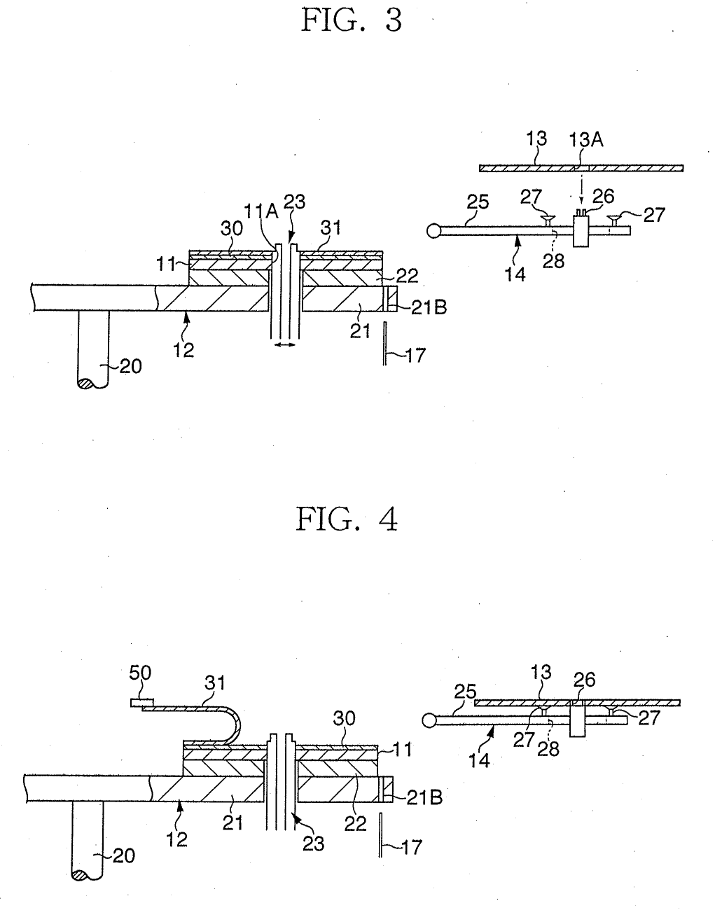

Next, a peeling tape 50 of a not shown peeling unit is stuck onto the upper peripheral portion of the protective sheet 31; the peeling tape 50 is pulled in the lateral direction whereby the protective sheet 31 is peeled off; and the resin layer 30 becomes exposed (see FIG. 4). And then, the positioning pin 23 is downsized radially.

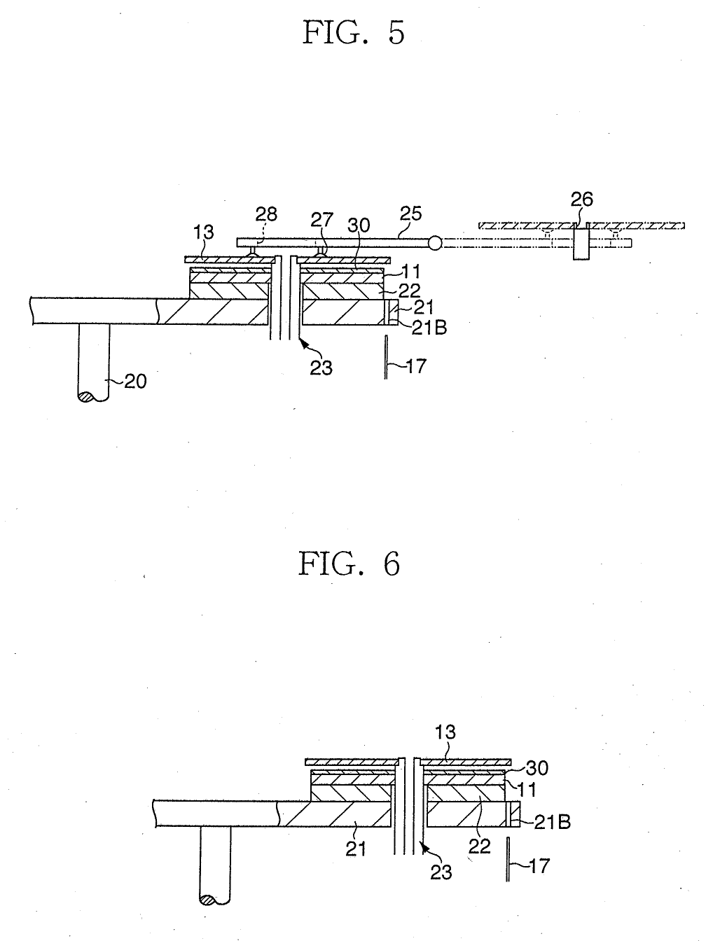

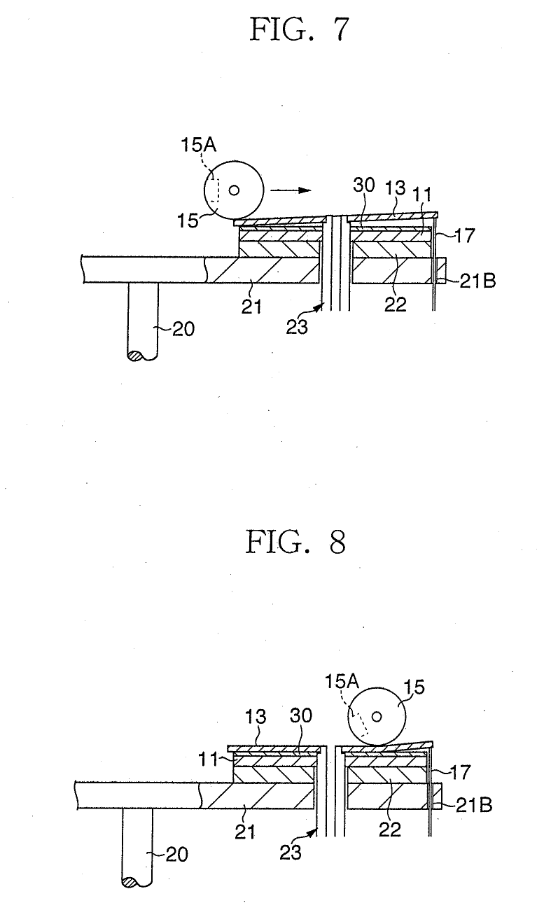

When the resin layer 30 is exposed as described above; the stamper 13 supported by the second supporting unit 14 is disposed in a position so that the positioning pin 23 can enter into the center penetration hole 13A of the stamper 13 by rotation of the turning arm 25; and centering is performed again by radially upsizing the positioning pin 23 (see FIG. 5). After the centering, the stamper 13 is maintained in the state that a slight space is left to the upper surface of the resin layer 30 (see FIG. 6). Then, the fore-contact preventing pin 17 goes up from near peripheral edge of the main table 21 as shown in FIG. 7, and abuts against any one radial edge portion of the stamper 13, whereby the stamper 13 is held in the stamping posture.

In this state, the pressing member 15 moves onto the stamper 13 at the opposite side of the abutted position with the fore-contact preventing pin 17, and moves rolling toward the fore-contact preventing pin 17 side, that is toward the right side in FIG. 7, thereby allows the stamper 13 to stamp on the resin layer 30, that is the disk substrate 11, while removing air existed between the stamper 13 and the resin layer 30 (see FIG. 8). In addition, when the pressing member 15 moves on the central positioning pin 23, the jut of the positioning pin 23 is set to fit into the recess 15A formed on the periphery of the pressing member 15, therefore an interference such as a physical contact between the pressing member 15 and the positioning pin 23 is avoided, and stamping can be performed while the positioning pin 23 firmly maintains the centering state of the disk substrate 11 and the stamper 13, whereby a problem such that the stamper 13 relatively slides in the planar direction to the disk substrate 11 by friction caused by the pressing force of the pressing member 15 can be prevented unfailingly. Incidentally, the positioning pin 23 and the fore-contact preventing pin 17 are pressed to a not-shown cylinder with a weak force of such level as capable of stamping while being depressed downward by the pressing force of the pressing member 15, thus the pressing member 15 passes through and thereafter the stamper 13 does not pop up again due to an adhesive force of the resin layer 30.

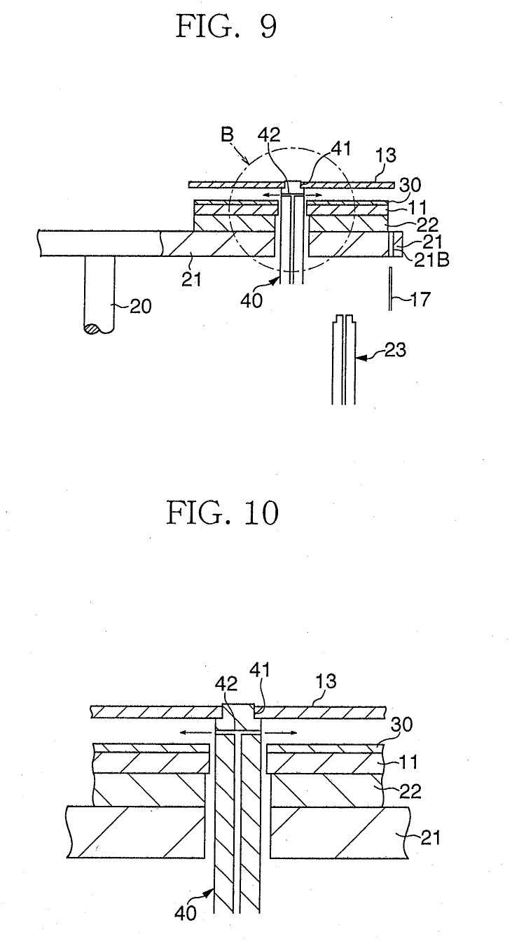

After completion of stamping with the stamper 13, a cure treatment is performed on the resin layer 30 by ultraviolet ray irradiation on the resin layer 30 via a not-shown ultraviolet curing unit. And then, as shown in FIG. 9 and FIG. 10, while the positioning pin 23 comes down and retracts to under the main table 21, the detaching member 40, which has been waiting up to then, alternatively enters into the both center holes 21A and 22A of the main table 21 and the suction table 22, and the reduced-diameter portion 41 goes through the center penetration hole 13A of the stamper 13 and rises, at the same time, air is jetted out from the air ejection holes 42, and that makes the stamper 13 uplift directly above and detaches the stamper 13 from the disk substrate 11.

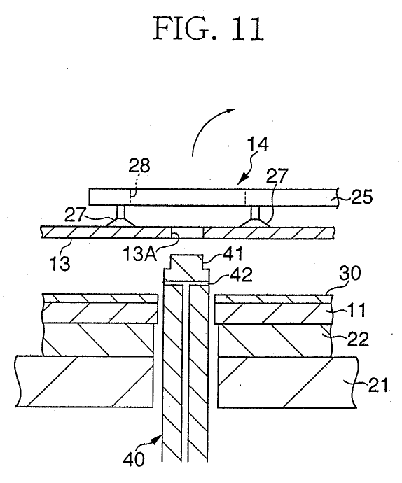

Accordingly, after the detachment of the stamper 13, as shown in FIG. 11, the stamper 13 is to return to the initial waiting position being sucked and held via the second supporting unit 14.

Therefore, according to the embodiment described above, such a configuration that one edge side of the stamper 13 is abutted thereon with the fore-contact preventing pin 17 so that the not-yet-contacted area is maintained in the suspended posture and the stamper 13 stamps on the disk substrate 11 by the pressing force of the pressing member 15 with preventing fore-contacts, enables to perform stamping without forming the decompression ambient while removing air which causes trapped air bubbles.

Moreover, to detach the stamper 13 after transferring the convex-concave and the like of the stamper 13 onto the resin layer 30 by stamping with the stamper 13, a configuration that the air is jetted out between the stamper 13 and the resin layer 30, enables to detach the stamper 13 smoothly as well as to impart an energy for detachment toward the perpendicular direction to the surface of the stamper 13, in the result, the transferred surface can be maintained with a high accuracy.

The best arrangement, method and the like for carrying out the present invention have been disclosed so far. However, the present invention is not limited to the above.

That is, the present invention has been illustrated and described mainly about a specific embodiment. However, it is possible for those skilled in the art to add various modifications, if necessary, to the above-described embodiment with respect to the shape, position and/or disposition without departing from the technical spirit and the range of the object of the present invention.

For example, in the above-described embodiment, an example in which an apparatus of the present invention is applied to stamping with the stamper 13 on the disk substrate 11 has been illustrated and described. However, the present invention is generally applicable to configurations for sticking plate-like members to each other.

In the embodiment, an example in which the fore-contact preventing pin 17 is worked on the peripheral area of the stamper 13 to form the not-yet-contacted area, has been described. However, working on the disk substrate 11 side to form the not-yet-contacted area, is also available. In this case, since the diameter of the disk substrate 11 is smaller than that of the stamper 13, the fore-contact preventing member is to be a member movable advancing and retracting along the surface of the disk substrate 11, and its forward end is to be moved in the perpendicular direction to the surface of the disk substrate 11 thereby enables to form the not-yet-contacted area.

1. A stamping apparatus, which is provided with a first supporting unit which supports a first plate-like member; a second supporting unit which supports a second plate-like member for stamping on the first plate-like member, and is disposed above the first plate-like member; and a pressing member which applies a pressing force on the first and the second plate-like members to perform stamping; comprising:
a fore-contact preventing member for forming a not-yet-contacted area by abutting against a peripheral area of either the first plate-like member or the second plate-like member; wherein
the pressing member applies the pressing force from the opposite side of the abutted position by the fore-contact preventing member to perform stamping of the first plate-like member with the second plate-like member.

2. The stamping apparatus according to claim 1, wherein
the first plate-like member is a disk substrate comprising an optical recording medium while the second plate-like member is a stamper for transferring fine convex-concave onto the surface of a resin layer provided on the disk substrate; and
the fore-contact preventing member abuts against the stamper to maintain the not-yet-contacted area of the stamper in a suspended posture.

3. The stamping apparatus according to claim 2, wherein
the first supporting unit comprises a positioning pin to perform centering of the disk substrate and the stamper; and
the pressing force is applied in a state that the positioning pin performs centering the disk substrate and the stamper so as to restrict relative slides of the disk substrate and the stamper.

4. The stamping apparatus according to claim 2, further comprising:
a detaching member having a diameter smaller than a diameter of a hole provided in the center of the disk substrate as well as an external diameter larger than the a diameter of a hole provided in the center of the stamper, being provided availably for insertion alternatively instead of the positioning pin; wherein
the detaching member performs a function of entering between the disk substrate and the stamper for pushing up the stamper so as to detach the stamper from the disk substrate.

5. The stamping apparatus according to claim 4, wherein the detaching member comprises an air supplying means for supplying air between the disk substrate and the stamper in a state that the stamper is pushed up.

6. A stamping method, which includes stamping of a first plate-like member with a second plate-like member by applying a pressing force on the first and the second plate-like members in a state of their faying surfaces, comprising:
forming a not-yet-contacted area by abutting against a peripheral area of either the first plate-like member or the second plate-like member; and
applying the pressing force from the opposite side of the abutted position thereby removing air from between the first plate-like member and the second plate-like member.

7. The stamping method according to claim 6, further comprising:
a function of detaching the second plate-like member from the first plate-like member by pushing up the second plate-like member while jetting out air therebetween after stamping the first and the second plate-like members.
